(19) United States
(12) Patent Application Publication
(10) Pub. No.: US 2003/0135138 A1
(43) Pub. Date: Jul. 17, 2003

(54) Transmission for a swing exerciser

(76) Inventor: Jung-Chun Tseng, Tao-Yuan City (TW)

Correspondence Address: Jung-Chun Tseng, P.O. Box No. 6-57, Chung-Ho, Taipei, TW

(21) Appl. No.: 10/042,328

(22) Filed: Jan. 11, 2002

(51) Int. Cl. A61H 1/02

(52) U.S. Cl. 601/35

(57) ABSTRACT

A transmission for a swing exerciser mainly has two ends of a link rod respectively and pivotally disposed onto a crank shaft and a rocking rod as well as a driving member composed by a motor and a variable speed gear for driving the crank shaft to rotate; when the crank shaft rotates, the crank shaft and the rocking rod drive the link rod to repetitively wind along an 8-shaped path thereby to allow the straddle seat thereon to make an user's leg portions swing left and right as well as lift up and down for exercising effect.

### BACKGROUND OF THE INVENTION

1) Field of the Invention

The present invention relating to a transmission for a leg swing exerciser aims to provide a transmission allowing a straddle seat on a swing exerciser to wind along an 8-shaped path for not only making the entire winding and swinging movement smoother, but also reducing the noise generation so as to increase the tranquility in application of the entire swing exerciser.

2) Description of the Prior Art

Accordingly, a general swing exerciser is mainly for an user to stretch his or her foot or leg portions on a straddle seat; the driving motion of the transmission inside the swing exerciser makes the straddle seat continuously and repetitively swing left and right, thereby relaxes the user's leg muscles and increase the blood circulation to achieve the effect of eliminating the tiredness of the leg portions; in addition to swing left and right for relaxing the leg's muscles, if the user's leg portions can also be lifted up at the same time, the effect of eliminating the tiredness thereat will be more obvious.

FIG. 1 shows a schematic drawing of a transmission of a conventional swing exerciser; an eccentric wheel (A1) works as a main moving member of the transmission (A); a link rod (A2) as a linking member for disposing a straddle seat (B) of a swing exerciser to allow the straddle seat (B) to move along with the link rod (A2); one end of the link rod (A2) is pivotally disposed onto the eccentric wheel (A1); a rail (A3) disposed horizontally forms a limiting and framing function to the other end of the link rod (A2); when the eccentric wheel (A1) turns, the link rod (A2) swings up and down through the rotation of the eccentric wheel (A1) as well as swings reciprocally left and right through the limitation and the framing of the rail (A3) to thereby allow the straddle seat (B) to wind repetitively along an 8-shaped pattern; therefore, when the user's leg portions are stretched on the straddle seat (B), the swing of the straddle seat (B) achieves the exercising effect of swinging the leg portions left and right as well as lifting the leg portions up and down.

However, since the convention transmission of the swing exerciser has one end of the link rod framed and limited in a rail, not only the movement of the driving is effected to result in making the straddle seat swing not smoothly due to the limitation of the rail, but also a lot of noise will be generated during the sliding or rolling displacement of the link rod in the rail and that thereby disturbs the user's rest.

### SUMMARY OF THE INVENTION

Therefore, the primary objective of the present invention of a transmission for a swing exerciser is to have two ends of a link rod for disposing a straddle seat thereof pivotally disposed onto a crank shaft and a rocking rod as well as to have a driving member composed by a motor and a variable speed gear for driving the crank shaft to rotate; when the crank shaft turns, the crank shaft and the rocking rod drive the link rod to repetitively wind along an 8-shaped path thereby to allow the straddle seat thereon to make an user's leg portions swing left and right as well as lift up and down for exercising effect.

Another objective of the present invention of a transmission for a swing exerciser is to, through two ends of a link rod pivotally disposed onto a crank shaft and a rocking rod, make all the members in the entire transmission move by turning each other so as to not only smooth the operation of the entire transmission more, but also reduce the generation of noise thereby to increase the tranquility in application of the entire swing exerciser.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is a schematic drawing of a transmission of a conventional swing exerciser.

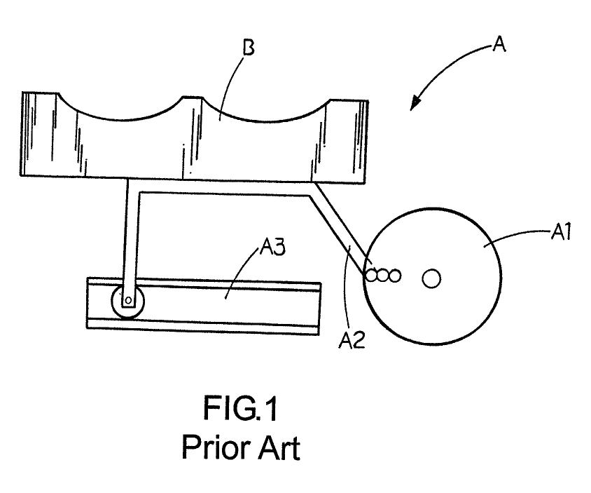

FIG. 2 is an external view drawing of the structure of a preferred exemplary embodiment of the present invention.

FIG. 3 is an exploded drawing of the structure of the present invention.

FIG. 4 is a schematic drawing of the application state of the present invention.

### DETAILED DESCRIPTION OF THE PREFERRED EMBODIMENTS

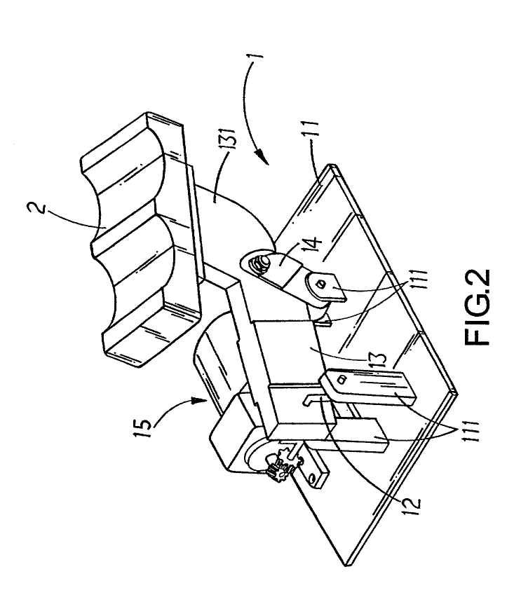

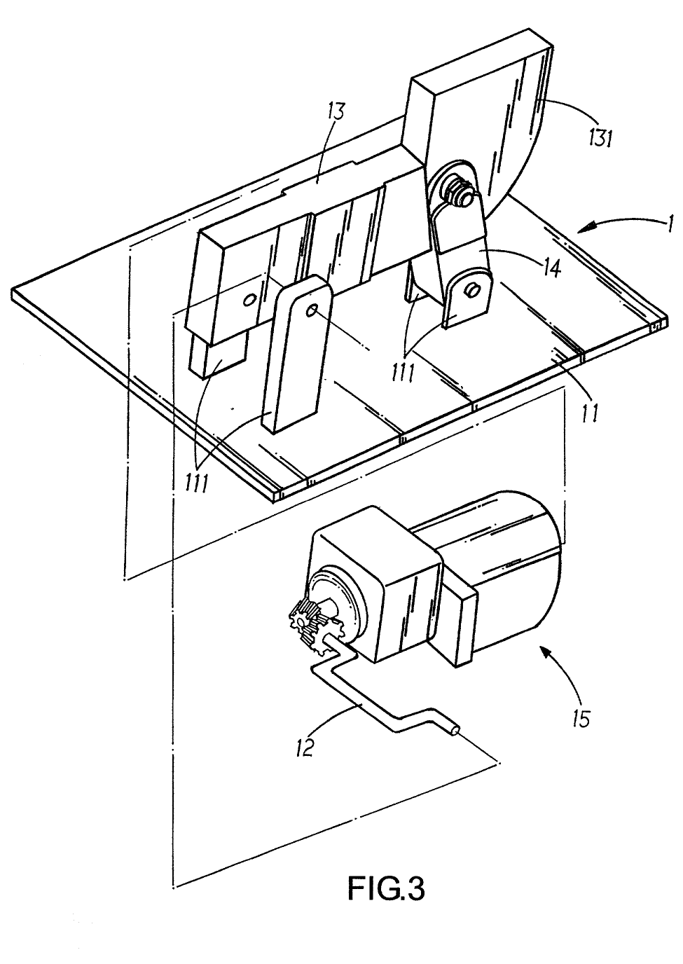

As shown in FIGS. 2 and 3, the basic composition of a transmission of the present invention of a transmission for a swing exerciser comprises a machine base (11) as the main body for the entire transmission (1); two pairs of straddling stands (111) are disposed on the machine base (11) and spaced in proper interval distance; a crank shaft (12) and a rocking rod (14) are respectively and pivotally disposed on the straddle stands (111); the entire transmission (1) uses a driving and turning member (15) composed by a motor and a variable speed gear as the dynamic source for the swing exerciser; the driving and turning member (15) is disposed on one side of the crank shaft (12) for driving the crank shaft (12) to rotate; a link rod (13) is disposed between the crank shaft (12) and the rocking rod (14); the link rod (13) is mainly used for disposing a straddle seat (2) to move along with the link rod (13).

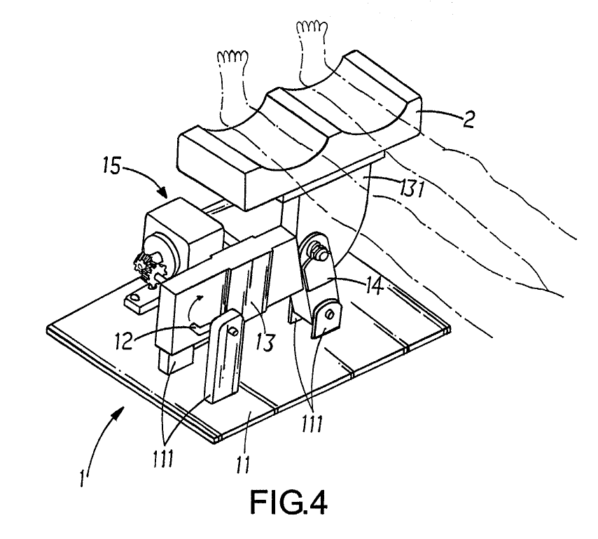

Two ends of the link rod (13) are respectively and pivotally disposed onto the crank shaft (12) and the rocking rod (14), when the crack shaft (12) turns, the crank shaft (12) and the rocking rod (14) drive the link rod (13) to repetitively wind along an 8-shaped path, as shown in FIG. 4; therefore, when an user's leg portions stretch on the straddle seat (2), the swing of the straddle seat (2) achieves the exercising effect by making the leg portions swing left and right as well as lift up and down.

Furthermore, one end of the link rod (13) for disposing the straddle seat (2) can form into an extending arm (131) accordingly to make the straddle seat (2) locate at a position in a proper height; more especially, two ends of the link rod (13) are pivotally connected to the crank shaft (12) and the rocking rod (14) so as to make all of the members in the entire transmission move by turning each other and that not only smoothes the movement of the entire transmission more, but also reduces the noise generation to increase the tranquility in application of the entire swing exerciser.

The present invention of a transmission for a swing exerciser has provided a preferred transmission by having two ends of a link rod for disposing a straddle seat thereof pivotally disposed onto a crank shaft and a rocking rod as well as having a driving member composed by a motor and a variable speed gear for driving the crank shaft to rotate; when the crank rotates, the crank shaft and the rocking rod drive the link rod to repetitively wind along an 8-shaped path thereby to allow the straddle seat thereon to make an user's leg portions swing left and right as well as lift up and down for exercising effect, furthermore, to smooth the entire movement of the transmission more and reduce the noise generation so as to increase the tranquility in application of the entire swing exerciser.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A present invention of a transmission for a swing exerciser has a transmission structure basically comprised of:
a machine base as the main body for the entire transmission and disposed with two pairs of straddle stands spaced in proper interval distance;
a crank shaft and a rocking rod respectively and pivotally disposed on the straddle stands;
a driving and turning member as the dynamic source of the swing exerciser and disposed on one side of the crank shaft for driving the it to rotate;
a link rod with two ends thereof respectively and pivotally connected to the crank shaft and the rocking rod;
a straddle seat disposed on and moving with the link rod;
accordingly, when the driving and turning member drives the crank shaft to turn, the crank shaft and the rocking rod drive the link rod to repetitively wind along an 8-shaped path so as to make an user's leg portion stretched on the straddle seat to swing left and right as well as lift up and down for exercising effect.

2. The present invention of a transmission for a swing exerciser according to claim 1, wherein the driving and turning member is composed by a motor and a variable speed gear.

3. The present invention of a transmission for a swing exerciser according to claim 1, wherein one end of the link rod for disposing the straddle seat forms into an extending arm accordingly so as to locate the straddle seat at a position in a proper height.
